(19) United States
(12) Patent Application Publication
(10) Pub. No.: US 2013/0212334 A1
(43) Pub. Date: Aug. 15, 2013

(54) Determining Optimal Preload Distance at Runtime

(71) Applicants: Gerald Paul Michalak, Cary, NC (US); Gregory Allan Reid, Raleigh, NC (US)

(72) Inventors: Gerald Paul Michalak, Cary, NC (US); Gregory Allan Reid, Raleigh, NC (US)

(73) Assignee: QUALCOMM INCORPORATED, San Diego, CA (US)

(21) Appl. No.: 13/369,548

(22) Filed: Feb. 9, 2012

(51) Int. Cl. G06F 12/08

(52) U.S. Cl. 711/137; 711/E12.057

(57) ABSTRACT

A run-time delay of a memory is measured, a run-time duration of a routine is determined, and an optimal run-time preload distance for the routine is determined based on the measured run-time memory delay and the determined run-time duration of the routine. Optionally, the run-time duration of the routine can be determined by measuring a run-time duration, and optionally the run-time duration can be determined based on a database of run-time delay for operations of the routine. Optionally, the optimal run-time preload distance is used in performing a loop of the routines.

### FIELD OF DISCLOSURE

The present disclosure relates to data processing and memory access and, more particularly, to preloading cache memory.

### BACKGROUND

Microprocessors perform computational tasks in a wide variety of applications. A typical microprocessor application includes software instructions to fetch data from a location in memory, perform one or more operations using the fetched data, store or accumulate the result, fetch more data, perform another one or more operations, and continue the process. The “memory” from which the data is fetched can be local to the microprocessor, or with a memory “fabric” or distributed resource to which the microprocessor is connected.

One metric of microprocessor performance is the processing rate, meaning the number of operations per second it can perform. The speed of the microprocessor itself can be raised by increasing the clock rate at which it can operate, for example by reducing the feature size of its transistors. However, since many microprocessor applications require fetching data from the memory fabric, increasing the clock rate of the microprocessor alone may be insufficient. Stated differently, absent in-kind increases in memory fabric access speed, increasing the microprocessor clock speed will only obtain increases in the amount time the microprocessor waits, without performing actual processing, for arrival of the data it fetches.

Related Art FIG. 1A shows one example timing 100 for four COMPUTE cycles (e.g. four iterations of a loop), each of a duration that will be referenced as “Compute Cycle Duration” or “CCD,” and a corresponding four MEMORY WAIT intervals, each of duration DLY, in a hypothetical processing by a microprocessor in combination with a memory fabric storing data and instructions. Each COMPUTE cycle, (i.e., each loop iteration), requires the microprocessor have data or instructions, or both, and these are fetched from the memory fabric during the MEMORY WAIT interval that precedes it. In the FIG. 1A example the CCD is approximately one-fourth the memory delay DLY. It will be understood that this example ratio of CCD to DLY is an arbitrary value, and that systems can exhibit other ratios. As can be seen, assuming this ratio of CCD to DLY, the processing is only 25% efficient. In other words, the processor spends three-fourths of its CPU cycles waiting for the memory.

One known technique that can enable some utilization of faster microprocessor clock rates, without an in-kind increase in the access speed of the memory fabric, is maintaining a cache memory local to the microprocessor. The cache memory can be managed to store copies of data and instructions that have been recently accessed and/or that the microprocessor anticipates (via software) accessing in the near future. In one known extension of the local cache memory technique, the microprocessor can be programmed to perform what are termed “preloads,” in which the data or instructions, or both, needed for performing a routine, or a portion of a routine, are fetched from the memory fabric and placed in the cache memory before the routine is performed.

FIG. 1B shows one example timing 150, in terms of CPU cycles, of a hypothetical processing in which a microprocessor uses a preloading of the data, or instructions, or both, needed to perform multiple iterations of the routine, before the first iteration. The FIG. 1B example timing 150 assumes the same arbitrary relative values of the memory delay DLY and routine processing duration CCD as used for the FIG. 1A example timing 100. In the FIG. 1B example, four preloads 152 are performed prior to a first COMPUTE cycle commencing at time T1, followed by receipt of the remaining three. As can be seen, the example process can then perform four consecutive COMPUTE cycles without waiting for the memory.

There can be issues with the conventional preload techniques. One issue is that the preload instructions need to be placed in the code last, after the code dynamics have settled. Another issue is that the preload distance, meaning how far ahead to preload, should ideally consider both the memory latency and the compute duration of the routine. This can be difficult to attain, because memory latency, and compute duration can vary between systems, and can vary over time in a system. A result can be too short a preload distance, which can manifest as the cache running out before iterations of a loop are complete. The CPU must stop loop execution and then (for example through the cache manager) take time (i.e., CPU cycles) to fetch data or instructions from memory before loop execution can continue. Another result can be too long of a preload distance, which can produce bunches in memory accesses at the front of the routine that can block other memory accesses.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any aspect. Its sole purpose is to present some concepts of one or more aspects in a simplified form as a prelude to the more detailed description that is presented later.

Methods according to one exemplary embodiment can provide optimizing a preloading of a processor from a memory, at run time and, in various aspects, can include measuring run-time memory latency of the memory to generate a measured run-time memory latency, determining a run-time duration of a routine on the processor and generating, as a result, a determined run-time duration, and determining a run-time optimal preloading distance based on the measured run-time memory latency and the determined run-time duration of the routine on the processor.

In an aspect, determining the run-time optimal preloading distance can include dividing the measured run-time memory latency by the determined run-time duration to generate a quotient, and rounding the quotient to an integer.

In another aspect, determining the run-time duration of the routine on the processor includes warming a cache used by the routine, performing the routine a plurality of times using the warmed cache, and measuring the time span required for performing the routine a plurality of times.

In an aspect, determining the run-time memory latency can include identifying a memory loading start time, performing a loading from the memory, starting at a start time associated with said memory loading start time, detecting the termination of the loading, identifying a memory loading end time associated with the termination, and calculating the measured run-time memory latency based on said memory loading start time and memory loading end time.

In a further aspect, identifying the memory loading start time can include reading a start value on a central processing unit (CPU) cycle counter, identifying the memory loading termination time includes reading an end value on the CPU cycle counter, and calculating the measured run-time memory latency can include calculating a difference between the end value and the start value.

In an aspect, calculating the measured run-time memory latency can include providing a processing system overhead for the reading of the CPU cycle counter, and adjusting the calculated, i.e., measured run-time memory latency based on the processing system overhead.

In one aspect, measuring the measured run-time memory latency can include storing a plurality of pointers comprising a last pointer and a plurality of interim pointers in the memory, each of the interim pointers pointing to a location in the memory of another of the pointers, reading the pointers, until detecting an accessing of the last pointer, measuring a time elapsed in reading the pointer, and dividing the time elapsed by a quantity of the pointers read to obtain the measured run-time memory latency as an estimated run-time memory latency.

In a further aspect, the reading of the pointers until detecting the accessing of the last pointer can include setting a pointer access location based on one of the interim pointers, accessing another of the pointers based on the pointer access location, updating the pointer access location based on the accessed another pointer, repeating the accessing another of the pointers and updating the pointer access location.

In an aspect, methods according to various exemplary embodiments can include providing a database of run-time duration for each of a plurality of processor operations and, in a related aspect, determining the run-time duration of the routine on the processor can be based on the database.

In another aspect, methods according to various exemplary embodiments can include performing N iterations of the routine and, during the performing, preloading a cache of the processor using the run-time optimal preloading distance.

In one related aspect, preloading the cache can include preloading the cache with data and instructions for a number of iterations of the routine corresponding to the run-time optimal preloading distance.

In another related aspect, performing the N iterations can include performing prologue iterations, each prologue iteration including one preloading without execution of the routine, performing body iterations, each body iteration including one preloading and one execution of the routine, and performing epilogue iterations, each epilogue iteration including one execution of the routine without preloading.

In one aspect, prologue iterations can fill the cache with data or instructions for a quantity of iterations of the routine equal to the run-time optimal preloading distance.

In an aspect, body iterations can perform a quantity of iterations equal to the run-time optimal preloading distance subtracted from N.

An apparatus according to one exemplary embodiment can provide optimizing a preloading of a processor from a memory, at run time and, in various aspects, can include means for measuring a run-time memory latency of the memory and generating a measured run-time memory latency, means for determining a run-time duration of a routine on the processor and generating, as a result, a determined run-time duration, and means for determining a run-time optimal preloading distance based on the measured run-time memory latency and the determined run-time duration of the routine on the processor.

Computer program products according to one exemplary embodiment can provide a computer readable medium comprising instructions that, when read and executed by a processor, cause the processor to perform operations for optimizing a preloading of a processor from a memory, at run time, and in various aspect the instructions can include instructions that cause the processor to measure run-time memory latency of the memory to generate a measured run-time memory latency, instructions that cause the processor to determine a run-time duration of a routine on the processor and to generate, as a result, a determined run-time duration, and instructions that cause the processor to determine a run-time optimal preloading distance based on the measured run-time memory latency and the determined run-time duration of the routine on the processor.

### BRIEF DESCRIPTION OF THE DRAWINGS

The accompanying drawings are presented to aid in the description of embodiments of the invention and are provided solely for illustration of the embodiments and not limitation thereof.

FIG. 1A shows a general microprocessor system utilization, in terms of system cycles for processing and system cycles for memory accessing, that can be achieved by a microprocessor system without preloading.

FIG. 1B shows a general microprocessor system utilization, in terms of system cycles for processing and system cycles for memory accessing, that can be achieved by a microprocessor system employing a stride-based preloading with a hypothetical matching, over an interval, of a stride in accordance with processing speed and memory fabric access.

FIG. 2 shows a logical flow diagram of one process to measure a run-time memory latency, in one method according to one exemplary embodiment.

FIG. 3 shows a logical flow diagram of one process to measure the duration of loop computation, in one method according to one exemplary embodiment.

FIG. 4 shows a logical block diagram of one process to measure the duration of loop computation, in one method according to one exemplary embodiment.

FIG. 5 shows a logical flow diagram of one loop process that includes preloading in accordance with one embodiment.

FIG. 6 shows an example relation of CPU cycles for computing routines and for preloading data and/or instructions according to a preload distance provided by methods and systems according to one or more embodiments.

FIG. 7 shows a logical flow diagram of one loop process that includes preloading in accordance with another embodiment.

FIG. 8 shows a logic flow diagram of one pointer chasing process according to one exemplary embodiment.

FIG. 9 shows one microprocessor and memory environment supporting methods and systems in accordance with various exemplary embodiments.

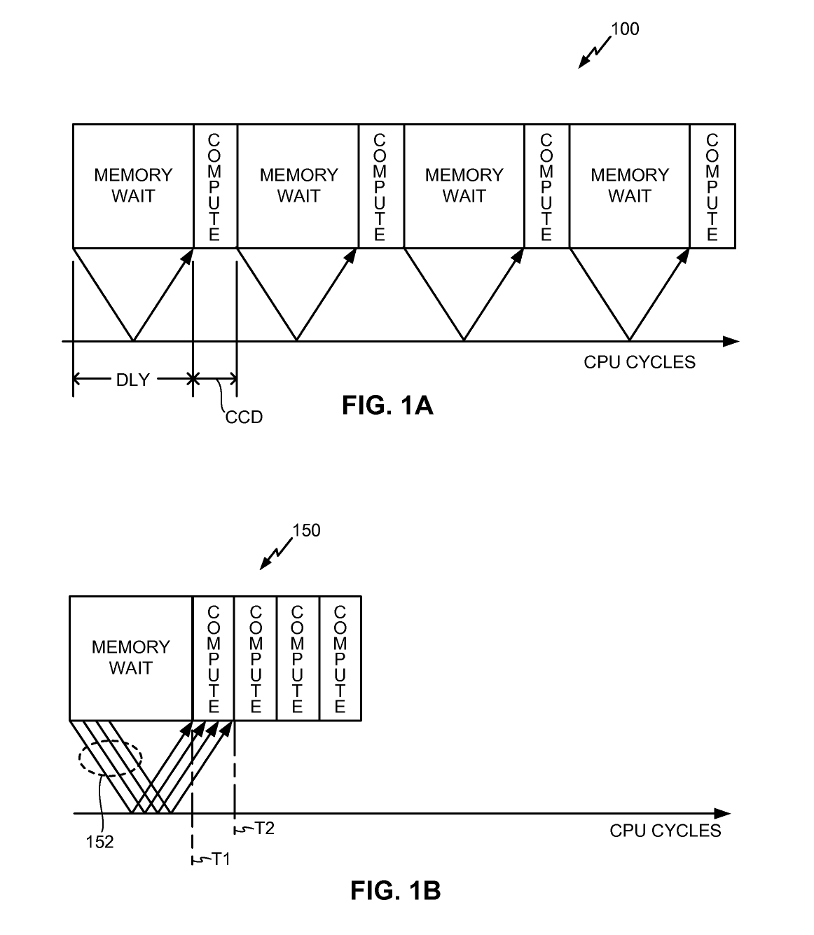

### DETAILED DESCRIPTION

Aspects of the invention are disclosed in the following description and related drawings directed to specific embodiments of the invention. Alternate embodiments may be devised without departing from the scope of the invention. Additionally, well-known elements of the invention will not be described in detail or will be omitted so as not to obscure the relevant details of the invention.

The word “exemplary” is used herein to mean “serving as an example, instance, or illustration.” Any embodiment described herein as “exemplary” is not necessarily to be construed as preferred or advantageous over other embodiments. Likewise, the term “embodiments of the invention” does not require that all embodiments of the invention include the discussed feature, advantage or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

Various embodiments can be implemented in a processing system including a central processing unit (CPU) having an arithmetic logic unit (ALU), a cache local to the ALU, an interface between the ALU and a bus, and/or an interface between the cache and the bus, one or more memory units coupled to the bus microprocessor, a cache manager configured to store and retrieve cache content, a CPU controller configured to read and decode computer-readable instructions and control the ALU, cache manager, or access the memory units through the interface in accordance with the instructions. In one embodiment, the CPU includes a CPU cycle counter accessible by, for example, the CPU controller.

It will be understood that described components of the CPU in the example processing system are logical features and do not necessarily correspond, in a one-to-one manner, with discrete sections of an integrated circuit (IC) chip, discrete IC chips, or other discrete hardware units. For example, embodiments can be implemented using a CPU having the ALU included in the CPU controller, or having a distributed CPU controller. In one embodiment the CPU can include a cache formed of a data cache and an instruction cache.

In one embodiment, the CPU can be one of a range of commercial microprocessor, for example, in no particular order as to preference, a Qualcomm Snapdragon®, Intel (e.g., Atom), TI (e.g., OMAP), or ARM Holdings ARM series processor, or the like.

Methods according to one embodiment can compute an optimal preload distance by a combination of measuring the memory latency at run time, computing the duration per loop at run time then, based on the measured run-time memory latency and computation duration values, computing the optimal preload distance. In accordance with this embodiment, and other disclosed embodiments, methods and systems can provide a preload distance that can be optimal at actual run-time, in an actual processing environment. Optimal preload distance provided by methods and systems according to the exemplary embodiments will be alternatively referred to as “optimal run-time preload distance.”

Methods according to one exemplary embodiment can include measuring a run-time memory latency by reading, at run time, a microprocessor cycle counter, which will be referenced in this description as the start value, then executing a load instruction for data at a test address and, upon completion of the load instruction, reading the microprocessor cycle counter and calling this the end value. The measured run-time memory latency will be a difference between the end value and the start value, in terms of CPU cycles. In an aspect, measuring run-time memory latency according to one exemplary embodiment can include clearing a local cache of the test data, to force the load instruction to access the test address, instead of simply returning a “hit” from the local cache. Measuring run-time memory latency according to one exemplary embodiment can include a data blocking operation to prevent the microprocessor from re-ordering operations and, hence, performing a number of machine cycles during the test that is not actually reflective of run-time memory latency.

Methods according to one exemplary embodiment can include measuring a run-time computation duration per loop. In one aspect, measuring a run-time computation duration per loop can include establishing a start time and then performing N calls for the routine and, upon the completion of the last call of the routine identifying an end time. The measured run-time computation duration can be calculated as a difference between the end value and the start value, divided by N.

In one embodiment, measuring the run-time computation duration can include warming the cache prior to conduction the measurement. In one aspect, warming the cache can include performing, for example, N iterations of the routine and employing conventional cache management techniques to store data or instructions, or both, likely to be needed by the routine.

In one embodiment, measuring the routine's computation duration per loop at run time can be done by a process that can be represented by the following pseudocode.

```
Start
  Call routine to be measured, for K iterations, 1^{st} call
  Start_time = read CPU cycle counter
  Call the routine to be measured, for N iterations, 2^{nd} call
  End_time = read CPU cycle counter
  Adjust for any fixed overhead in reading the CPU cycle counter
  Routine compute duration per loop = (end_time − start_time)/N
```

In one alternative embodiment, measuring a routine's compute duration can be approximated by estimating the compute duration. The compute duration estimate can be generated using instruction latency tables.

Methods and systems according to one embodiment can include computing an optimal run-time preload distance in a manner that can be represented by the following:

$$RTPD = ceiling ( \frac{MEM\_DELAY}{M\_CDPL} ) , \qquad Equation ( 1 )$$

where
“MEM_DELAY” is the measured run-time memory latency,
“M_CDPL” is the measured computation duration per loop,
“ceiling” is an operation of rounding up to the next integer, and
“RTPD” is the optimal run-time preload distance, in units of loops.

In one embodiment, MEM_DELAY and M_CDPL can be units of CPU cycles. In one alternative embodiment, MEM_DELAY and M_CDPL can be units of a system timer, as described in greater detail at later sections.

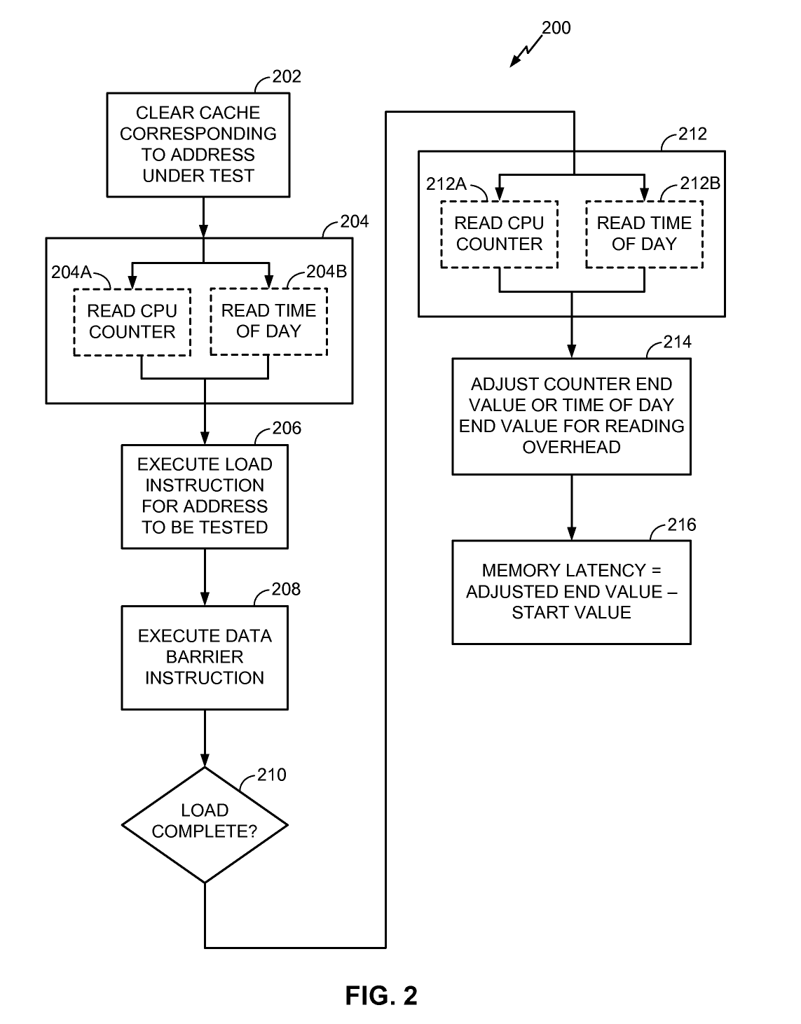

FIG. 2 shows a logical flow diagram of one run-time memory latency measurement process 200 of one method according to one exemplary embodiment.

Referring to FIG. 2, in one embodiment the run-time memory latency measurement process 200 can begin with clearing, at 202, a cache corresponding to the addresses in the memory fabric for which latency is being measured. Persons of ordinary skill in the art, having view of the present disclosure, can readily implement this clearing at 202 of the cache using conventional code-writing know-how such persons possess, applied to the specific processor system environment in which measurement being performed. Further detail description is therefore omitted. After the clearing at 202 the run-time memory latency measurement process 200 can go to 204 to set a start time. In one embodiment, setting the start time at 204 can include reading, at 204A, a CPU cycle counter (not shown in FIG. 2) of the CPU of the processor system environment in which the run-time memory latency is being measured. As will be understood by persons of ordinary skill in the art having view of the present disclosure, in some processing environments an administrative privilege can be required to read a CPU cycle counter. As will also be appreciated by such persons, system privilege controls can make it not fully practical to include in an application a read of a CPU cycle counter. To address such matters, and to provide further and alternative features, in another embodiment that is described in greater detail at later sections, setting the start time at 204 can include performing a “time-of-day” read, for example at 204B, in place of reading a CPU cycle counter.

Referring still to FIG. 2, after the 204 setting of the start time the run-time memory latency measurement process 200 can go to 206 where it executes a load instruction for an address within the range of addresses being tested. In an aspect, selection of the specific load instruction, and the setting of selectable access or loading parameters, if any, that bear on run-time memory latency, can be in accordance with the specific load instruction(s) and setting of loading parameter(s), if any, that will be used by the application that will utilize the preloading calculated according to the exemplary embodiments.

Referring still to FIG. 2, after executing at 206 of the load instruction, the run-time memory latency measurement process 200 can, in one embodiment go to 208 where it can execute a data barrier instruction. Data barrier instructions, as known to persons of ordinary skill in the art, can be used to prevent a CPU from re-ordering instructions. As will be apparent to persons of ordinary skill in the art having view of the present disclosure, a re-ordering could significantly affect the accuracy of the measured run-time memory latency. Such persons can readily apply conventional techniques, known to such persons as being particular to the specific processing system environment in which the run-time memory latency measurement process 200 is being performed. Further detailed description of techniques for implementing the data barrier instructions at 208 is therefore omitted. It will be understood that run-time memory latency measurements in accordance with one or more embodiments may be performed, in practices on certain processing system environments, without data barrier instructions at 208. For example, pointer chasing can be used in methods and systems according to one or more exemplary embodiments, and examples are described in greater detail at later sections. Regarding data barrier instructions, as one example, on an ARM Inc. architecture version 7 processor, a DSB (data synchronization barrier) instruction is available.

Continuing to refer to FIG. 2, in one embodiment environment the run-time memory latency measurement process 200, after executing the data barrier instruction at 208, or immediately after the commencing the load instruction at 206 in embodiments omitting the executing of the data barrier instruction at 208, can go to 210 to await completion of the data load instruction at 206. It will be understood that the awaiting at 210 is not necessarily separate from the execution of the load instruction at 206. In other words, “executing the load instruction” at 206 can include the awaiting completion and the detection of completion at 210. In one embodiment, upon detecting at 210 completion of the load instruction executed at 206 the run-time memory latency measurement process 200 can go to 212, to detect the end time of the load instruction executed at 206, in other words read the time at which the load instruction commenced executed at 206 was detected as complete. In one embodiment, which can be used in combination with embodiments that detect the start time at 204A by reading a CPU cycle counter, detecting at 212 the end time of the load instruction executed at 206 can include reading, at 212A, the same CPU cycle counter. In another embodiment, which can be used in combination with embodiments that detect the start time at 204B by reading a time of day, detect at 212 the end time of the load instruction executed at 206 and, at 212B, perform another reading of the time day. As will be described in greater detail at later sections, based on a difference between the ending and starting time of day, in combination with statistical processing, an accurate estimation of the number of CPU cycles of the run-time memory latency can be provided.

Referring still to FIG. 2, in one embodiment the run-time memory latency measurement process 200 can, after detecting at 212 the end time of the loading process executed at 206, go to 214 to perform an adjustment of the end time to compensate for CPU cycles used in detecting the start time. In embodiments that include detecting the start time at 204A and detecting the end time at 212A by reading the CPU cycle counter, the adjustment at 214 can include subtracting from the CPU cycle count read at 212A the number of CPU cycles required to perform that read of the CPU cycle counter. In other words, the run-time memory latency measurement process 200 can include, in embodiments that measure memory latency using the CPU cycle counter, compensation for the overhead in reading that CPU cycle counter. In one alternative, in embodiments that include detecting the start time day at 204B and detecting the end time of day at 212B, the adjustment at 214 can include subtracting at 204B from the time of day read at 212B the overhead incurred in that reading.

Continuing to refer to FIG. 2, after compensating for overhead at 214, the run-time memory latency measurement process 200 can, in one embodiment, go to 216 where it sets the measured run-time memory latency (MEM_DELAY) based on a difference between a start time detected at 204 and an end time detected at 212 and a start time detected at 204, compensated at 214 for overhead. In embodiments that measure the value of MEM_DELAY based on the CPU cycle counter, the MEM_DELAY is the CPU cycle counter read at 204A and then subtracted from the CPU cycle counter read at 212A adjusted or compensated at 214 for the overhead of reading that CPU cycle counter.

With continuing reference to FIG. 2, it will be understood that the compensation for overhead at 214 is not necessarily performed directly on the CPU cycle counter read at 212A. For example, in one embodiment, the compensation for overhead at 214 can be included in the subtraction at 216 of CPU counter values or of system timer values.

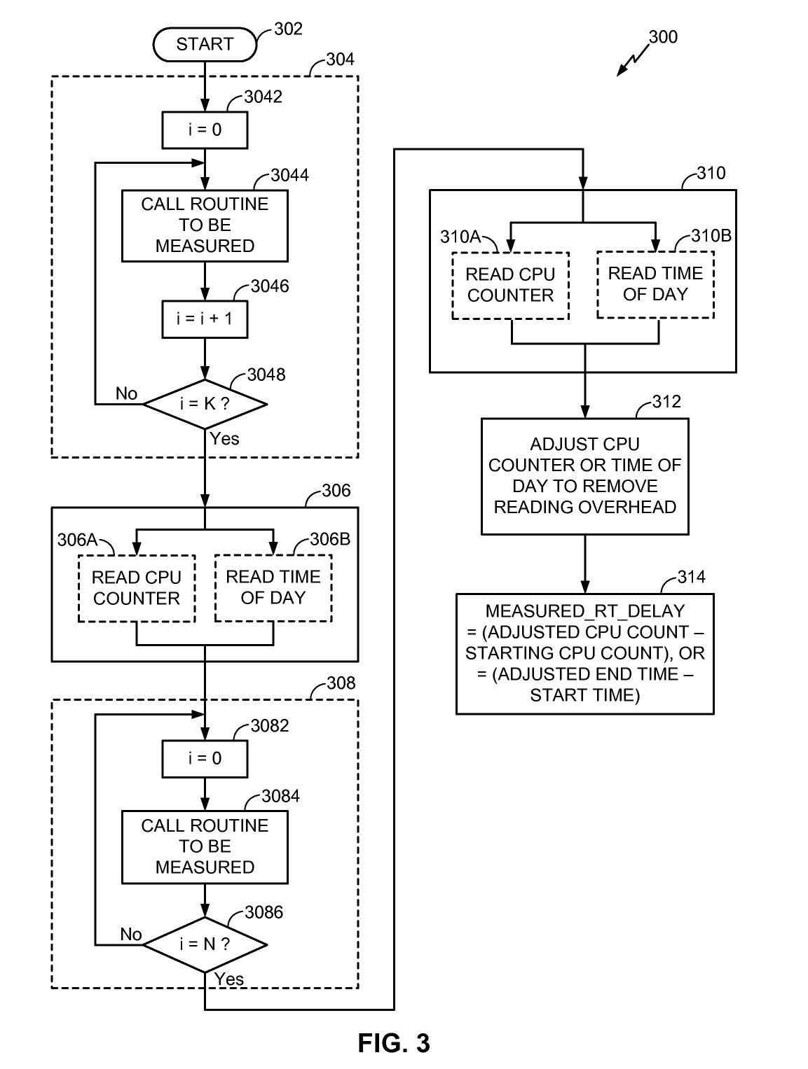

FIG. 3 shows a logical flow diagram of one loop duration measurement process 300 to measure the duration of one loop, meaning execution of a given routine that will in actual application be executed in a loop manner, in one method according to one exemplary embodiment.

Referring to FIG. 3, in one embodiment the loop duration measurement can obtain the loop duration that will be exhibited when the cache is preloaded with the data and instructions needed for that loop. As will be appreciated by persons of ordinary skill in the art, having view of this disclosure, in methods and system according to the exemplary embodiments obtaining such measurement can further provide for a run-time optimized preload distance. In one aspect, obtaining measurement of the run-time computation duration of a loop that will be exhibited when the cache is preloaded with the data and instructions needed for that loop can be provided by the measurement itself including a preloading of the cache.

With continuing reference to FIG. 3, the computation duration measurement process 300 can, further to one aspect, provide such preloading of the cache by performing at 304 what will be termed a “warming” of the cache. The warming of the cache at 304 can include running K iterations of the loop immediately prior to the measurement. In one example, the warming of the cache at 304 can include initializing at 3042 an index “i” of a loop counter (not shown in FIG. 3), then at 3044 calling the routine to be measured, upon completion incrementing the loop counter at 3046 and, after repeating the iterations K times, the conditional block 3048 can pass the loop computation duration measurement process 300 to 306. At 306 the loop duration measurement process 300 can obtain a start time where, in one aspect, “start time” can be a CPU cycle counter value, for example as can be read at 306A. In an alternative or supplemental aspect, the start time can be obtained by reading a time of day, such as at 306B.

Referring still to FIG. 3, in one example, after obtaining the start time at 306, the loop computation duration measurement process 300 can go to 308 where it iterates the routine N times, using the warmed cache memory provided at 304. In one embodiment the iteration at 308 can at 3082 initialize the index “i” to a 0 value, i.e., reset the loop counter, and then go to 3084 where it can call the routine to be measured. In association with the calling, or executing, of the routine at 3084 the loop computation duration measurement process 300 can increment the index “i,” i.e., increment the loop counter, and then proceed to the conditional block 3086. If the index “i” has not yet reached N, the loop computation duration measurement process 300 can return to 3084 and again call the routine to be measured. When the index “i” reaches N the conditional block 3086 sends the loop computation duration measurement process 300 to 310 to obtain the end or termination time. Further to the aspect in which “start time” was obtained by reading a CPU cycle counter value, the end time can be obtained by again reading, for example at 310A, the CPU cycle counter value. Further to the alternative or supplemental aspect in which the start time was obtained by reading a time of day, the end time can be obtained by again reading the time of day.

With continuing reference to FIG. 3, after obtaining the end time at 310, the loop computation duration measurement process 300 can, in one embodiment, go to 312 to adjust for, or compensate for, any fixed overhead incurred in that 310 obtaining of the end time. For example, in one aspect, at 312 a fixed overhead can be subtracted from the CPU cycle counter read at 310A. In another aspect, at 312 a fixed overhead can be subtracted from the system timer read at 310B. It will be understood that the compensation adjustment for overhead at 312 is not necessarily performed directly on the CPU cycle counter value read at 310. In one embodiment, for example, the compensation or adjustment for overhead at 312 can be included in the subtraction at 314, explained in greater detail below, of CPU counter values.

Referring still to FIG. 3, after compensating or adjusting for overhead at 312 or, in one aspect, immediately after obtaining the end time at 310, the loop computation duration measurement process 300 can go to 314 to calculate the measured computation duration per loop, alternatively referenced as M_CDPL. In one embodiment, M_CDPL can be calculated or obtained at 314 by subtracting the start time (where “time” can be a CPU counter value) obtained at 306 from the end time obtained at 310, or from the end time obtained at 310 as adjusted for overhead at 312, and dividing the difference by N. In other words, according to this embodiment, the M_CDPL is an average value. In an aspect in which the start time and end time are read as CPU cycle count, M_CDPL can be an average quantity of CPU cycles.

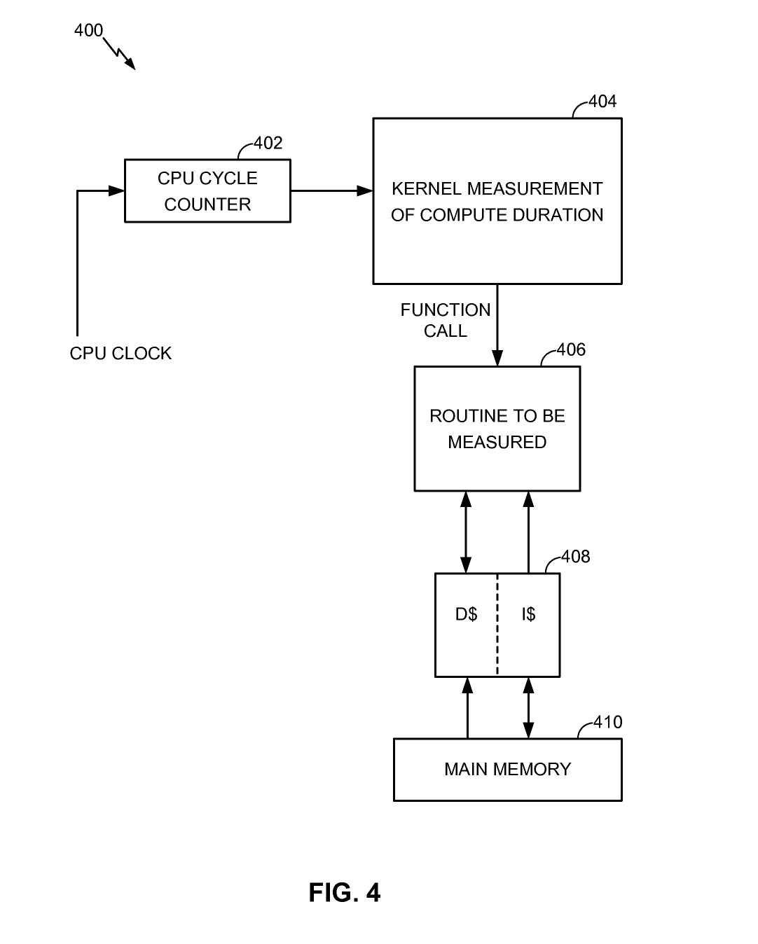

FIG. 4 shows, as a representation that can be alternative to, or supplemental to the FIG. 3 logical flow diagram of the loop computation duration measurement process 300, a logical block diagram of one routine computation duration measurement module 400 in one system, and for practicing methods according to one or more exemplary embodiments. Referring to FIG. 4, one routine computation duration measurement module 400 can include CPU cycle counter 402 that receives a CPU CLOCK and, in turn, feeds a kernel measurement of compute duration 404 that can, for example, be implemented by the microprocessor (not explicitly shown in FIG. 4). The routine computation duration measurement module 400 can further include computer instructions stored in the memory (not explicitly shown in FIG. 4) of the microprocessor system in which the measured memory delay MEM_DELAY and measured computation duration per loop M_CDPL are obtained. In one embodiment, the computer instructions component of the kernel measurement of compute duration 404 can be loaded or stored in a cache (not explicitly shown in FIG. 4) local to the CPU (not explicitly shown in FIG. 4) of the processing system being measured. In one embodiment, the computer instructions component of the kernel measurement of compute duration 404 can include computer instructions that, when read by the CPU of the processing system being tested, cause the CPU to perform a method in accordance with the loop computation duration measurement process 300.

Referring still to FIG. 4, the CPU cycle counter 402 can, in one aspect, be a CPU cycle counter module having, for example, a combination of a CPU cycle counter device (not separately shown) and computer readable instructions that cause the CPU, or a controller device (not explicitly shown by FIG. 4) associated with the CPU, to read the CPU cycle counter device. The CPU cycle counter 402 can, in one embodiment, implement the CPU cycle counter read 306A and 310A of the FIG. 3 loop computation duration measurement process 300.

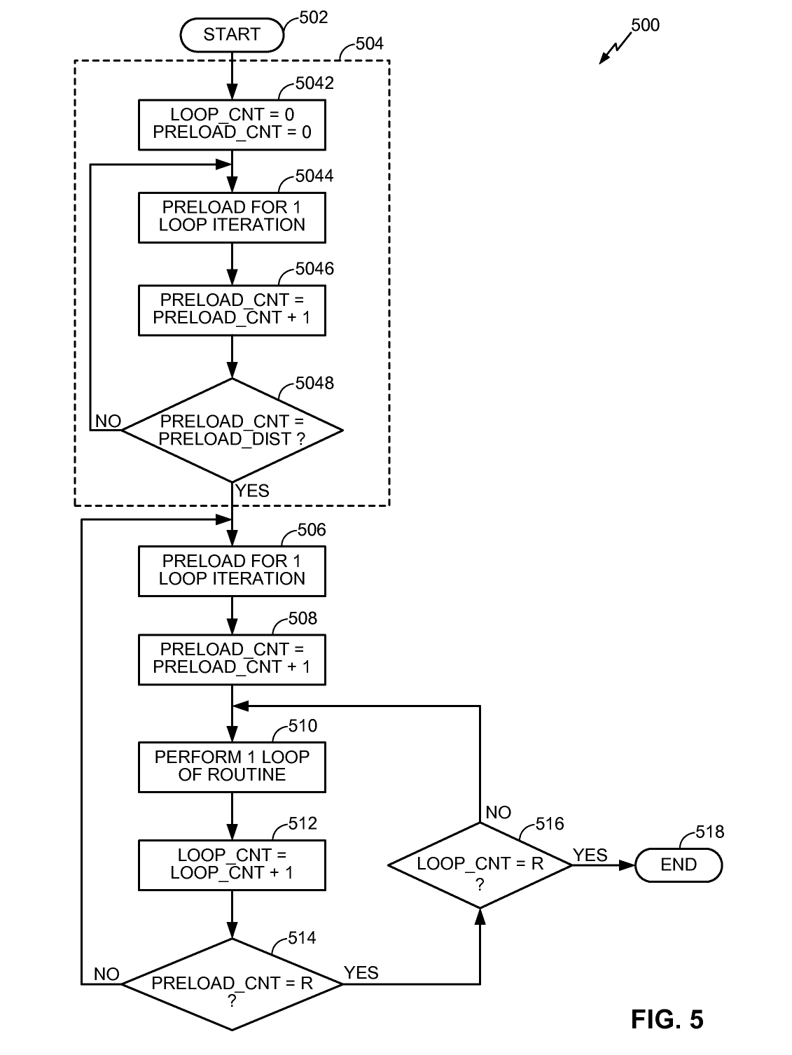

Continuing to refer to FIG. 4, one routine computation duration measurement module 400 can include, or can have access to, a module 406 having the routine for which the measured computation duration per loop M_CDPL is to be obtained. The module 406 can include the CPU of the processing system in which the M_CDPL is being obtained, in combination with computer readable instructions stored, for example, in the memory of the processing system. In one embodiment, one routine computation duration measurement module 400 can include, or can have access to, a cache module 408. The cache module 408 can include a data cache module, such as the example labeled “D$,” and an instruction cache module, such as the example labeled “IS.” The cache module, in one embodiment, can be implemented according to conventional cache hardware and cache management techniques, adapted in accordance with the present disclosure to perform according to the disclosed embodiments. The cache module 408 can implement, in one aspect, the cache that is warmed at 304 of the FIG. 3 loop computation duration measurement process 300. The cache module 408 can implement, in one aspect, the cache that is preloaded in accordance with the exemplary embodiments, such as described in greater detail in reference to FIGS. 5, 6 and 7, at later sections of this disclosure.

Referring still to FIG. 4, one routine computation duration measurement module 400 can include, or can have access to a main memory 410. The main memory 410, in one embodiment, can be implemented according to conventional memory fabric techniques, adapted in accordance with the present disclosure to perform according to the disclosed embodiments.

After obtaining the measured run-time memory latency MEM_DELAY and the measured computation duration per loop M_CDPL, in methods and systems according to one embodiment RTPD, the optimal run-time preload distance, can be calculated. In one embodiments, RTPD can be calculated in accordance with Equation (1) above, by dividing MEM_DELAY by M_CDPL and, if a non-integer quotient results, applying the ceiling operation of rounding up to the next integer. For example, if MEM_DELAY has an arbitrary value of, say, 100, and M_CDPL has an arbitrary value of, say 30, the quotient will be 3.3333, which is a non-integer. The ceiling operation, for these arbitrary values of MEM_DELAY and M_CDPL will therefore yield an optimal RTPD of four.

FIG. 5 shows a logical flow diagram of one optimal preload loop process 500 that includes preloading with an optimal RTPD run-time in accordance with one embodiment. Example operations of the optimal preload loop process 500 will assume that a loop of R iterations, R being a given integer, is being executed. Referring to FIG. 5, one optimal preload loop process 500 can begin from an arbitrary start state 502 and go to a prologue 504 that preloads the cache (not shown in FIG. 5) with data, or instructions, or both, for performing a number of loops equal to the optimal RTPD. The FIG. 5 logical flow diagram of one optimal preload loop process 500 labels the optimal RTPD as “PRELOAD_DIST.” In one optimal preload loop process 500, the prologue 504 can begin with an initialization at 5042 to initialize, e.g., to set to zero, a loop index for counting preloads, PRELOAD_CNT, and a loop index, LOOP_CNT, for counting loops of executing the routine for which the PRELOAD_DIST was obtained. It will be appreciated that PRELOAD_DIST, as described in reference to FIGS. 2, 3 and 4, is optimal for the routine in its particular, current run-time environment. The prologue 504, after the initialization at 5042, can go to 5044 to preload data, or instructions, or both, for one loop iteration (i.e., one execution of the routine), and then to 5046 to increment the preload count index PRELOAD_CNT.

In an aspect, the prologue 504, after incrementing PRELOAD_CNT by one at 5046, goes to the conditional block 5048. If PRELOAD_CNT is less than the PRELOAD_DIST, the prologue 504 returns to 5044 to preload data, or instructions, or both for another loop. The prologue 504 continues until PRELOAD_CNT equals PRELOAD_DIST, whereupon the conditional block 5048 can send the optimal preload loop process 500 to 506 to initiate a preload of data or instructions, or both, for another loop, and then to 508 to increment PRELOAD_CNT by one. In one embodiment, the optimal preload loop process 500 can proceed from the 508 incrementing PRELOAD_CNT to 510 where it can perform an iteration of the loop. It will be understood that the 510 iteration of the loop can be done without waiting for the preload initiated at 506 to finish. It will also be understood that the one iteration of the routine performed at 510 can, as provided by one or more embodiments, use the first preload performed at 5044 of the prologue 504.

Referring to FIG. 5, after performing one iteration of the routine at 510, one optimal preload loop process 500 can proceed to 512, increment LOOP_CNT, and then to the conditional block 514. In one embodiment, at conditional block 514, if PRELOAD_CNT is less than R an optimal preload loop process 500 can return to 506 to perform another preload, then to 508 where it increments PRELOAD_CNT, then to 510 where it performs another iteration of the routine, then to 512 to increment LOOP_CNT, and then returns to the conditional block 514. The loop, from 514 to 506, then through 508, 510, then to 512 and back to 514 will, in one aspect, continue until PRELOAD_CNT is equal to R. The optimal preload loop process 500, in one embodiment, can then go to another conditional block 516 that compares LOOP_CNT to R. The conditional block 516 operates to terminate the optimal preload loop process 500 when R iterations of the routine have been performed. It will be appreciated that at the first instance of the optimal preload loop process 500 entering the conditional block 516 LOOP_CNT will be less than R. The reason is that the prologue 504 performed PRELOAD_DIST preloads before the first instance of performing, at 510, an iteration of the routine. Therefore, at that first instance of entering the conditional block 516 the optimal preload loop process 500 goes to 510 where it performs another iteration of the routine, then to 512 to increment LOOP_CNT, through the conditional block 514 because PRELOAD_CNT remains at R, and back to the conditional block 516. It will be appreciated that this loop, from the conditional block 516 to 510 to 512 to 514 and back to 516—each loop incrementing LOOP_CNT—will continue until LOOP_CNT equals R, whereupon the optimal preload loop process 500 goes to a logical end or termination state 518.

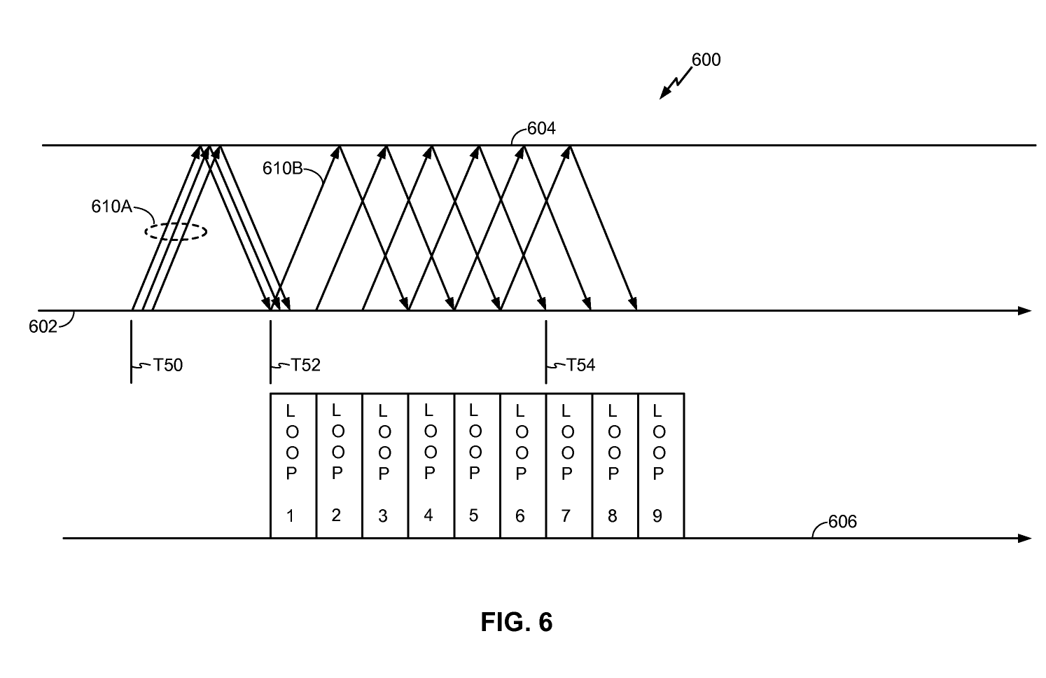

FIG. 6 shows an example relation 600 of CPU cycles for computing routines and for preloading data and/or instructions according to a preload distance provided by methods and systems according to one or more embodiments. Line 602 represents CPU cycles at the interface of the CPU of the processor system to the memory fabric, line 604 represents a hypothetical ping interface within the memory fabric, and line 606 represent CPU cycles in relation to performing loops, each loop being an iteration of a routine. The example relation 600 assumes an optimal run-time preload distance RTPD=3, and an R=9. It will be understood that these are arbitrarily selected value not intended as any limitation on any embodiment or any aspect thereof. Referring to FIG. 6, CPU cycles from T50 to T52 can represent 3 preloads 610A performed during a prologue, for example the FIG. 5 prologue 504. At T52 another preload 610B is initiated and a first loop, LOOP_1, is performed. The preload 610B can, for example, be a first instance of the FIG. 5 preload at 506, and LOOP_1 can be a first instance of the FIG. 5 performing, at 510, an iteration of the routine. T54 can be the first instance at which the number of preloads performed is detected equal to R, and therefore, no further preloads will be performed. Referring to the optimal preload loop process 500 of FIG. 5, the FIG. 6 T54 can correspond to the first instance at conditional block 514 where PRELOAD_CNT=R.

Continuing to refer to FIG. 6, in one aspect LOOP_7 . . . LOOP_9 can correspond, referring to FIG. 5, successive performance at 510 of an iteration of the optimal preload loop process 500 looping from conditional block 514 to conditional block 516, then to 510 where the iteration of the routine is performed, then to 512 to increment LOOP_CNT, and back to the conditional block 514, until LOOP_CNT is detected equal to R, in this example, 9, by the conditional block 516. As can be seen by persons of ordinary skill from the described example operations according to optimal preload loop process 500, in an aspect the number of iterations through the prolog can, preferably, match the number of iterations through the epilogue.

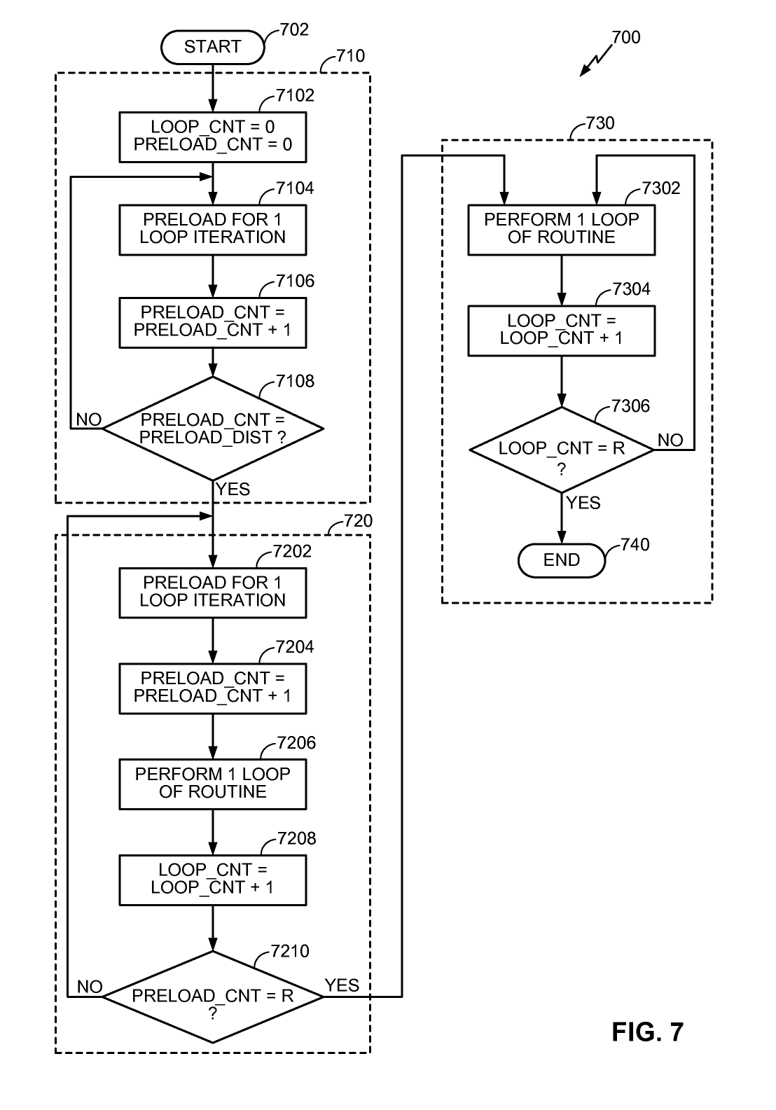

FIG. 7 shows a logical flow diagram of one optimal preload loop process 700 that includes preloading in accordance with another embodiment. Examples will be described assuming R loops of a routine for which an optimal run-time preload distance has been obtained in accordance with one or more exemplary embodiments. For example, it may be assumed that run-time memory latency MEM_DELAY has been measured using the FIG. 2 the run-time memory latency measurement process 200, and the measured computation duration per loop M_CDPL obtained using the FIG. 3 run-time loop duration measurement process 300, or the FIG. 4 routine computation duration measurement module 400. Referring to FIG. 7, in one embodiment the optimal preload loop process 700 can begin at an arbitrary start state 702 and then go to prologue 710. The prologue 710, in one aspect, preloads the cache with data or instructions, or both, for PRELOAD_DIST loops.

Continuing to refer to FIG. 7, in one optimal preload loop process 700 the prologue 710 can begin with an initialization at 7102 to initialize, e.g., to set to zero, a loop index for counting preloads, PRELOAD_CNT, and a loop index, LOOP_CNT, for counting loops of executing the routine for which the PRELOAD_DIST was obtained. It will be appreciated that PRELOAD_DIST, as described in reference to FIGS. 2, 3 and 4, is optimal for the routine in its particular, current run-time environment. The prologue 710, after the initialization at 7102, can go to 7104 to preload data, or instructions, or both, for one loop iteration (i.e., one execution of the routine), and then to 7106 to increment the preload count index PRELOAD_CNT.

Continuing to refer to FIG. 7, and continuing with description of on example operation of the prologue 710, after incrementing PRELOAD_CNT by one at 7106. In one example optimal preload loop process 700 can go to the conditional block 7108. If PRELOAD_CNT is less than the PRELOAD_DIST the prologue 710 can, in one aspect, return to 7104 to preload data, or instructions, or both for another loop. The prologue 710, in one aspect, continues until PRELOAD_CNT equals PRELOAD_DIST, whereupon the conditional block 7108 can send the optimal preload loop process 700 to a body 720. In the body 720, in one aspect, iterations of the routine are performed that include a preload of the cache. The body 720, further to this one aspect, can continue until R preloads have been performed.

Referring still to FIG. 7, in one embodiment the body 720 can include a preload at 7202 for an iteration of the routine, followed by incrementing PRELOAD_CNT at 7204, performing a loop routine at 7206, incrementing LOOP_CNT at 7210, and going to the conditional block 7208. The body 720, in one aspect, can repeat the above-described loop until the conditional block 7210 detects that R preloads have been performed. In one embodiment, the optimal preload loop process 700 can, after completion of the body 720, go to the epilogue 730. The epilogue 730 performs iterations of the routine using data and instructions obtained from preloads not used by the body 720. In one embodiment, the epilogue 730 can include performing at 7302 an iteration of the loop routine, an associated incrementing at 7304 of LOOP_CNT, until the conditional block 7306 detects LOOP_CNT equal to R, in other words until R iterations of the loop routine have been performed. In one aspect, the optimal preload loop process 700 can then go the end or termination state 740.

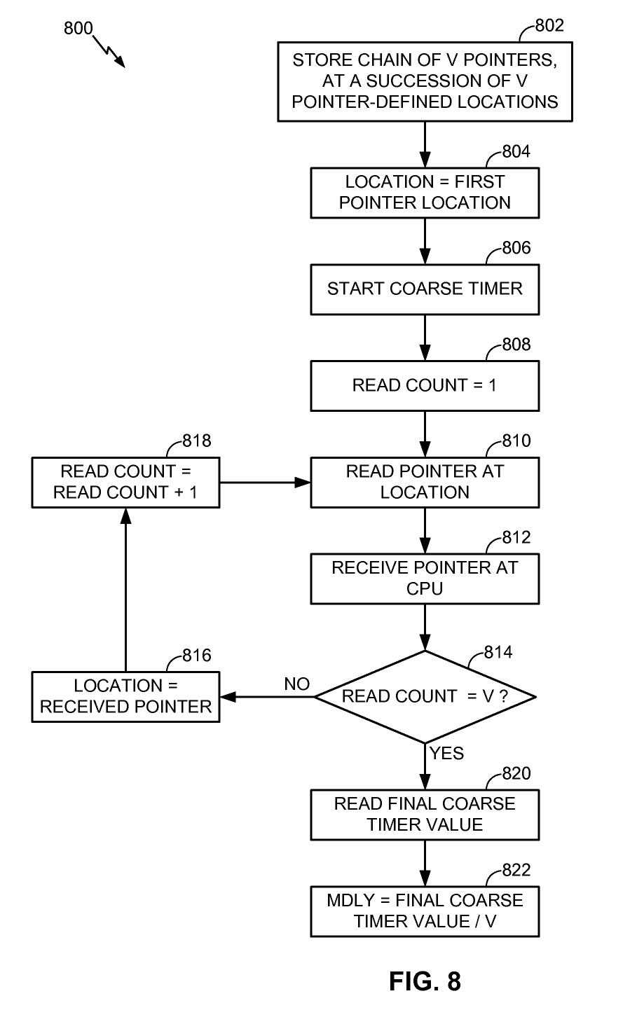

In one embodiment, measurements of run-time memory latency and compute duration can be provided without need for privileged access to hardware counters or cache management. In one embodiment, run-time memory latency can be calculated using, for example, gettimeofday( ) calls and statistical post-processing. In another embodiment, a measurement of run-time memory latency can be provided by a “pointer chasing” that, in overview, can include reading a chain of V pointers from the memory, which will require V full access times because each step requires receipt of the accessed pointer before it can proceed to the next of the V accesses. FIG. 8 shows one pointer chasing process 800 according to one exemplary embodiment. Referring to FIG. 8, in an aspect, the pointer chasing process 800 can include starting at 802 with a CPU storing a chain of V pointers at V locations in the memory, V being an integer. In one aspect the first pointer points to the second, the second to the third, and so forth. Therefore, according to this aspect the CPU only needs to retain the address of the first pointer.

Continuing to refer to FIG. 8, in an aspect pointer chasing process 800 can include, after 802 storing a chain of pointers, the CPU going to 804 where it can initialize a LOCATION, for example by loading an address register (not shown) with the address (i.e., location), of the first pointer. In one aspect, the pointer chasing process 800 can, after initializing the LOCATION at 804, go to 806 and start, e.g., set to zero, a coarse timer. The term “coarse timer” is used because the duration of time it will measure is approximately V times the average access time, as opposed to having to measure the much shorter duration of a single access.

With continuing reference to FIG. 8, in one aspect, after initializing the coarse timer at 806 the pointer chasing process 800 can go to 808 and set a READ COUNT to 1. As described in greater detail below, in an aspect the READ COUNT is incremented after each of the V pointers is accessed and, when the value reaches V, an iteration loop is terminated. After setting the READ COUNT to 1 at 808 the pointer chasing process 800 can, in a further aspect, go to 810 where the CPU can initiate a read access of the memory being measured, to obtain the first of the V pointers, using the address of the first pointer provided at 804. A function of the pointer chasing process 800 is to measure memory access delay and, therefore, the process does not advance to the test block 814 until the pointer (in this instance the first pointer) accessed at 810 is received by the CPU. Further to this aspect, upon receiving this pointer at 812 the pointer chasing process 800 can go to the escape or termination condition block 814 to determine if V of the pointer reads have been performed. Since the description at this point is at a first iteration of the V reads, the READ COUNT is less than V, so pointer chasing process 800 can, in response to detecting a “No” at the termination condition block 814, go to 816 where the CPU updates the LOCATION used for the next read to be the pointer (in this instance the first pointer” received from the memory at 812. Continuing with this example, in one aspect, after updating the LOCATION at 816 the pointer chasing process 800 can go to 818 where it increments the READ COUNT by 1, and then to 810 to read the location pointed to by the pointer received at the previous receiving 812, which in this first iteration is the first pointer which, in turn can be the address of the second pointer.

Referring still to FIG. 8, the above-described process can, according to one concept, continue until the READ COUNT detected at 814 is V. Upon meeting this condition, the escape or termination pointer chasing process 800 can go 820, read the coarse timer, and then to 822 where it can divide the elapsed time reflected by the coarse timer by V, which is the number of iterations. The result of the division will be an estimate of the memory access delay, or MEM_DELAY. It will be understood that if V is a power of two the division can be a right shift of the log(base 2) of the elapsed time.

Referring still to FIG. 8, it will be appreciated that the coarse timer, e.g., Getimeofday( ) feature, can be more readily available to user applications than the nanosecond resolution counter access that could be used to measure individual memory access times. It will also be understood by persons of ordinary skill in the art having view of the present disclosure that alternative means for detecting completion of accessing all of the pointers can be employed. For example, instead of counting the number of accesses, the last pointer in the chain can be assigned a particular last pointer value and, after each access returns a next pointer to the CPU, the next pointer can be compared to the last pointer value. When a match is detected, the reading process terminates and the elapsed time divided by the READ_COUNT as previously described.

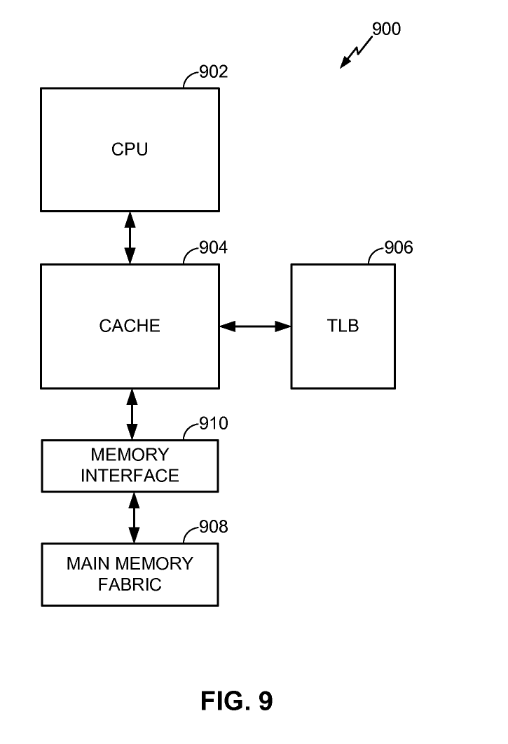

FIG. 9 depicts a functional block diagram of a processor 900. The 900 may embody any type of computing system, such as a server, personal computer, laptop, a battery-powered, pocket-sized hand-held PC, a personal digital assistant (PDA) or other mobile computing device (e.g., a mobile phone).

In one embodiment, the processor 900 can be configured with a CPU 902. In one embodiment, the CPU 902 can be a superscalar design, with multiple parallel pipelines. In another embodiment CPU 902 can include various registers or latches, organized in pipe stages, and one or more Arithmetic Logic Units (ALU).

In one embodiment, the processor 900 can have a general cache 904, with memory address translation and permissions managed by a main Translation Lookaside Buffer (TLB) 906. In another embodiment a separate instruction cache (not shown) and a separate data cache (not shown) may substitute for, or one or both can be additional to the general cache 904. In an aspect of embodiments having one or both of a separate data cache and instruction cache, the TLB 906 can be replaced by, or supplemented by, a separate instruction translation lookaside buffer (not shown) or a separate data translation lookaside translation buffer (not shown), or both. In another embodiment the processor 900 can include a second-level (L2) cache (not shown) for the general cache 906, or for any of a separate instruction cache or data cache, or both.

The general cache 904, together with the TLB 906 can, in one embodiment, be in accordance with conventional cache management, with respect to detection of misses and actions corresponding to the same. For example, in an aspect of this one embodiment, misses in the general cache can cause an access to a main (e.g., off-chip) memory, or memory fabric, such as the memory fabric 908, under the control of, for example, the memory interface 910. Similarly, in an aspect of embodiments using one or both of a separate data cache and a separate instruction.

It will be understood that the main memory fabric 908 may be representative of any known type of memory, and any known combination of types of memory. For example, memory fabric 908 may include one or more of a Single Inline Memory Module (SIMM), a Dual Inline Memory Module (DIMM), flash memory (e.g., NAND flash memory, NOR flash memory, etc.), random access memory (RAM) such as synchronous RAM (SRAM), magnetic RAM (MRAM), dynamic RAM (DRAM), electrically erasable programmable read-only memory (EEPROM), and magnetic tunnel junction (MTJ) magnetoresistive memory.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The methods, sequences and/or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

Accordingly, an embodiment of the invention can include a computer readable media embodying a method in accordance with any of the embodiments disclosed herein. Accordingly, the invention is not limited to illustrated examples and any means for performing the functionality described herein are included in embodiments of the invention.

While the foregoing disclosure shows illustrative embodiments of the invention, it should be noted that various changes and modifications could be made herein without departing from the scope of the invention as defined by the appended claims. The functions, steps and/or actions of the method claims in accordance with the embodiments of the invention described herein need not be performed in any particular order. Furthermore, although elements of the invention may be described or claimed in the singular, the plural is contemplated unless limitation to the singular is explicitly stated.

What is claimed is:

1. A method for optimizing a preloading of a processor from a memory, at run time, comprising:
measuring a run-time memory latency of the memory and generating, as a result, a measured run-time memory latency;
determining a run-time duration of a routine on the processor and generating, as a result, a determined run-time duration;
determining a run-time optimal preloading distance based on the measured run-time memory latency and the determined run-time duration of the routine on the processor.

2. The method of claim 1, wherein determining the run-time optimal preloading distance includes dividing the measured run-time memory latency by the determined run-time duration to generate a quotient, and rounding the quotient to an integer.

3. The method of claim 1, wherein determining the run-time duration of the routine on the processor includes warming a cache associated with the routine to obtain a warmed cache, performing the routine a plurality of times using the warmed cache, and measuring a time span required for performing the routine a plurality of times.

4. The method of claim 1, wherein measuring the run-time memory latency includes:
identifying a memory loading start time;
performing a loading from the memory, starting at a start time associated with said memory loading start time;
detecting a termination of the loading;
identifying a memory loading termination time associated with the termination of the loading; and
calculating the measured run-time memory latency based on said memory loading start time and the memory loading end time.

5. The method of claim 4, wherein identifying the memory loading start time includes reading a start value on a central processing unit (CPU) cycle counter, identifying the memory loading termination time includes reading an end value on the CPU cycle counter, and wherein calculating the measured run-time memory latency includes calculating a difference between the end value and the start value.

6. The method of claim 5, further comprising:
providing a processing system overhead for said reading of the CPU cycle counter;
adjusting the measured run-time memory latency based on the processing system overhead.

7. The method of claim 4, wherein identifying the memory loading start time includes reading a system timer, identifying the memory loading termination time includes reading the system timer.

8. The method of claim 7, further comprising:
providing a processing system overhead for said reading of the system timer;
adjusting the measured run-time memory latency based on the processing system overhead.

9. The method of claim 1, wherein measuring the run-time memory latency includes:
storing a plurality of pointers comprising a last pointer and a plurality of interim pointers in the memory, each of the interim pointers pointing to a location in the memory of another of the pointers;
reading the pointers, the reading comprising
setting a pointer access location based on one of the interim pointers,
accessing another of the pointers based on the pointer access location,
updating the pointer access location based on an another accessed pointer resulting from accessing another of the pointers,
repeating the accessing of another of the pointers and updating the pointer access location until detecting an accessing of the last pointer;
measuring a time elapsed in reading the pointers; and
dividing the time elapsed by a quantity of the pointers read to obtain an estimated run-time memory latency as the measured run-time memory latency.

10. The method of claim 9, further comprising
initializing an access counter in association with a start of reading the pointers;
incrementing the access counter in association with accessing another of the pointers; and comparing the access counter to a termination count,
wherein detecting the accessing of the last pointer is based on a result of the comparing.

11. The method of claim 9, wherein the last pointer has a last pointer value, and
wherein detecting the accessing of the last pointer is based on detecting another accessed pointer matching the last pointer value.

12. The method of claim 1, further comprising providing a database of run-time duration for each of a plurality of processor operations, and wherein determining the run-time duration of the routine on the processor is based on the database of run-time duration.

13. The method of claim 1, further comprising performing N iterations of the routine and, during the performing, preloading a cache of the processor using the run-time optimal preloading distance.

14. The method of claim 13, wherein preloading the cache includes preloading the cache with data and instructions for a number of iterations of the routine corresponding to the run-time optimal preloading distance.

15. The method of claim 14, wherein performing the N iterations of the routine includes a preloading of the cache at each iteration of the routine, and counting a number of instances of the preloading.

16. The method of claim 13, wherein performing the N iterations of the routine comprises:
performing prologue iterations, each prologue iteration including one preloading without execution of the routine;
performing body iterations, each body iteration including one preloading and one execution of the routine; and
performing epilogue iterations, each epilogue iteration including one execution of the routine without preloading.

17. The method of claim 16, wherein the prologue iterations fill the cache with data or instructions for a quantity of iterations of the routine equal to the run-time optimal preloading distance.

18. The method of claim 17, wherein the body iterations perform a quantity of iterations equal to the run-time optimal preloading distance subtracted from N.

19. The method of claim 13, wherein determining the run-time duration of the routine includes measuring a time span of performing the N iterations of the routine, generating a corresponding measured time span, and dividing the measured time span by N.

20. An apparatus for optimizing a preloading of a processor from a memory, at run time, comprising:
means for measuring run-time memory latency of the memory and generating, as a result of the measuring, a measured run-time memory latency;
means for determining a run-time duration of a routine on the processor and generating, as a result, a determined run-time duration; and
means for determining a run-time optimal preloading distance based on the measured run-time memory latency and the run-time duration of the routine on the processor.

21. The apparatus of claim 20, wherein determining the run-time optimal preloading distance includes quotient the measured run-time memory latency by the run-time duration to generate a quotient, and rounding the quotient up to an integer.

22. The apparatus of claim 20, wherein determining the run-time duration of the routine on the processor includes warming a cache associated with the routine to obtain a warmed cache, performing the routine a plurality of times using the warmed cache, and measuring a time span required for performing the routine a plurality of times.

23. The apparatus of claim 20, wherein the means for measuring the run-time memory latency includes:
means for identifying a memory loading start time;
means for performing a loading from the memory, starting at a start time associated with said memory loading start time;
means for detecting the termination of the loading;
means for identifying a memory loading termination time associated with the termination of the loading; and
means for calculating the measured run-time memory latency based on said memory loading start time and memory loading end time.

24. The apparatus of claim 23, wherein identifying the memory loading start time includes reading a start value on a central processing unit (CPU) cycle counter, identifying the memory loading termination time includes reading an end value on the CPU cycle counter, and wherein calculating the measured run-time memory latency includes calculating a difference between the end value and the start value.

25. The apparatus of claim 23, further comprising:
means for adjusting the measured run-time memory latency based on a processing system overhead for said reading of the CPU cycle counter.

26. The apparatus of claim 23 wherein identifying the memory loading start time includes reading a system timer, and identifying the memory loading termination time includes reading the system timer.

27. The apparatus of claim 26, further comprising:
means for providing a processing system overhead for said reading of the system timer; and
means for adjusting the measured run-time memory latency based on the processing system overhead.

28. The apparatus of claim 20, wherein the means for measuring the run-time memory latency includes
means for storing a plurality of pointers comprising a last pointer and a plurality of interim pointers in the memory, each of the interim pointers pointing to a location in the memory of another of the pointers;
means for reading the pointers;
means for measuring a time elapsed in reading the pointers; and
means for dividing the time elapsed by a quantity of the pointers read to obtain an estimated run-time memory latency as the measured run-time memory latency.

29. The apparatus of claim 28, wherein reading the pointers includes:
setting a pointer access location based on one of the interim pointers,
accessing another of the pointers based on the pointer access location to provide another accessed pointer,
updating the pointer access location based on the accessed another pointer, and
repeating the accessing of another of the pointers and updating the pointer access location until detecting an accessing of the last pointer.

30. The apparatus of claim 29, wherein reading the pointers further comprises:
initializing an access counter in association with a start of reading the pointers;
incrementing the access counter in association with accessing another of the pointers; and comparing the access counter to a termination count,
wherein detecting the accessing of the last pointer is based on a result of the comparing.

31. The apparatus of claim 28, wherein identifying the memory loading start time includes reading a system timer, wherein identifying the memory loading termination time includes reading the system timer,
wherein the last pointer has a last pointer value, and
wherein detecting the accessing of the last pointer is based on detecting the accessed another pointer matching the last pointer value.

32. The apparatus of claim 28, further comprising:
means for providing a processing system overhead for said reading of the system timer; and
means for adjusting the measured run-time memory latency based on the processing system overhead.

33. The apparatus of claim 20 further comprising means for preloading a cache of the processor with data and instructions for a number of iterations of the routine corresponding to the run-time optimal preloading distance.

34. The apparatus of claim 20, wherein determining the run-time duration of the routine includes measuring a time span of performing the N iterations of the routine and generating, in response, a measured time span, and dividing the measured time span by N.

35. The apparatus of claim 20, wherein the apparatus is integrated in at least one semiconductor die.

36. The apparatus of claim 20, further comprising a device, selected from the group consisting of a set top box, music player, video player, entertainment unit, navigation device, communications device, personal digital assistant (PDA), fixed location data unit, and a computer, into which the apparatus is integrated.

37. A computer product having a computer readable medium comprising instructions that, when read and executed by a processor, cause the processor to perform operations for optimizing a preloading of a processor from a memory, at run time, the instructions comprising:
instructions that cause the processor to measure run-time memory latency of the memory to generate a measured run-time memory latency;
instructions that cause the processor to determine a run-time duration of a routine on the processor and to generate a resulting determined run-time duration;
instructions that cause the processor to determine a run-time optimal preloading distance based on the measured run-time memory latency and the determined run-time duration of the routine on the processor.

38. The computer product of claim 37, wherein instructions that cause the processor to determine the run-time optimal preloading distance includes instructions that cause the processor to divide the measured run-time memory latency by the determined run-time duration to generate a quotient, and round the quotient to an integer.

39. The computer product of claim 37, wherein instruction that cause the processor to determine the run-time duration of the routine on the processor include instructions that cause the processor to warm a cache associated with the routine to obtain a warmed cache, perform the routine a plurality of times using the warmed cache, and measure a time span required for performing the routine a plurality of times.

40. The computer product of claim 37, wherein instructions that cause the processor to determine the run-time duration of the routine on the processor include instruction that the cause the processor to measure a time span of performing N iterations of the routine, and divide the time span of performing the routine N times by N.

41. The computer product of claim 37, wherein instructions that cause the processor to measure the run-time memory latency include:
instructions that cause the processor to identify a memory loading start time;
instructions that cause the processor to perform a loading from the memory, starting at a start time associated with said memory loading start time;
instructions that cause the processor to detect a termination of the loading;
instructions that cause the processor to identify a memory loading termination time associated with the termination of the loading; and
instructions that cause the processor to calculate, based on said memory loading start time and memory loading end time, the measured run-time memory latency.

42. The method of claim 41, wherein identifying the memory loading start time includes reading a start value on a central processing unit (CPU) cycle counter, identifying the memory loading termination time includes reading an end value on the CPU cycle counter, and wherein calculating the measured run-time memory latency includes calculating a difference between the end value and the start value.

43. The computer product of claim 42, further comprising:
instructions that cause the processor to provide a processing system overhead for said reading of the CPU cycle counter;
instructions that cause the processor to adjust the measured run-time memory latency based on the processing system overhead.

44. The computer product of claim 41, wherein instructions that cause the processor to identify the memory loading start time includes instructions that cause the processor to read a system timer, and wherein instructions that cause the processor to identify the memory loading termination time include instructions that cause the processor to read the system timer.

45. The method of claim 44, further comprising:
providing a processing system overhead for said reading of the system timer;
adjusting the measured memory latency based on the processing system overhead.

46. The computer product of claim 37, further comprising instructions that cause the processor to determine the run-time duration of the routine on the processor based on a given database of run-time duration for each of a plurality of processor operations.

47. The computer product of claim 37, further comprising instructions that cause the processor to perform N iterations of the routine and, during the performing, to preload a cache of the processor using the run-time optimal preloading distance.

48. The computer product of claim 47, wherein instructions that cause the processor to perform the N iterations include instructions that cause the processor to preload the cache at each iteration of the routine, and to count a number of instances of the preloading.

49. The computer product of claim 47, wherein instructions that cause the processor to perform the N iterations comprises:
instructions that cause the processor to perform prologue iterations, each prologue iteration including one preloading without execution of the routine;
instructions that cause the processor to perform body iterations, each body iteration including one preloading and one execution of the routine; and
instructions that cause the processor to perform epilogue iterations, each epilogue iteration including one execution of the routine without preloading.

50. The computer product of claim 49, wherein the prologue iterations fill the cache with data or instructions for a quantity of iterations of the routine equal to the run-time optimal preloading distance.

51. The computer product of claim 50, wherein the body iterations perform a quantity of iterations equal the run-time optimal preloading distance subtracted from N.
